(19) United States
(12) Patent Application Publication
(10) Pub. No.: US 2025/0087378 A1
(43) Pub. Date: Mar. 13, 2025

(54) High Temperature Reactor With Reduced Silo Height

(71) Applicant: Wisconsin Alumni Research Foundation, Madison, WI (US)

(72) Inventors: Ben Lindley, Middleton, WI (US); Peter Wilkinson, Cambridge (GB)

(21) Appl. No.: 18/566,460

(22) PCT Filed: Jun. 21, 2022
(86) PCT No.: PCT/US2022/034239

§ 371 Date: Dec. 1, 2023

Related U.S. Application Data
(60) Provisional application No. 63/218,622, filed on Jul. 6, 2021.

(51) Int. Cl. G21C 7/11; G21C 7/14

(52) U.S. Cl. CPC G21C 7/11; G21C 7/14

(57) ABSTRACT

A nuclear reactor comprising: a core of nuclear fuel having a height; a pressure vessel surrounding the core of nuclear fuel to allow circulation of gas there through; a set of neutron-absorbing control rods movable for insertion and withdrawal into and out of the core along a respective axis for control of a nuclear reaction in the core, each of the neutron-absorbing control rods comprising mutually sliding elements moving relative to each other between an extended position separated along the axis in a first direction over a first length and a compacted position overlapping over a second length less than the first length and less than 51% of the core height; and a control rod mechanism communicating with the control rods to move them for insertion and withdraw into and out of the core.

### CROSS REFERENCE TO RELATED APPLICATION

This application claims the benefit of U.S. provisional application 63/218,622 filed Jul. 6, 2021 and hereby incorporated by reference

### STATEMENT REGARDING FEDERALLY SPONSORED RESEARCH OR DEVELOPMENT

### BACKGROUND OF THE INVENTION

The present invention relates to nuclear reactors and, in particular, to a telescopic control rod for nuclear reactors reducing the cost of the pressure vessel.

Nuclear reactors include a core containing nuclear fuel, the latter generating heat through a nuclear chain reaction in which released neutrons promote additional reactions. The chain reaction is moderated through the use of control rods which may be inserted into the core to absorb neutrons and by this means control the “reactivity” of the nuclear reactor to a value close to one, providing a constant thermal output.

In a high temperature reactor (HTR), heat is extracted from the core using a circulating gas, such as helium, pressurize to increase its heat carrying capacity. The gas is contained by a pressure vessel surrounding the core. The pressure vessel is itself contained within a silo which is at least partly below ground. Excavating the silo represents a significant cost in the reactor design. Normally, the control rods are inserted vertically downwardly into the core by a control rod mechanism positioned above the core. Space above the core and within the pressure vessel is provided to hold the control rods when they are fully removed. The control rod mechanism for moving the control rods, may be positioned outside of the pressure vessel and communicates with the control rods through openings in the pressure vessel.

### SUMMARY OF THE INVENTION

The present inventors have determined that telescopic control rods can be used to substantially reduce the height of the reactor silo, substantially decreasing the cost of the reactor as a result of a superlinear relationship between silo height and cost. Importantly, the inventors have determined that this cost reduction offsets any expected decrease in the lifetime of the control rod, particularly where more than two sliding components are used. The inventors have determined that as many as five elements, (or potentially more) are practical and can reduce the height of the pressure vessel by at least 80%.

In one embodiment, the present invention provides a nuclear reactor having a core of nuclear fuel contained within a pressure vessel surrounding the core to allow circulation of gas therethrough. A set of neutron-absorbing control rods are provided, movable for insertion and withdrawal into and out of the core along a respective axis for control of a nuclear reaction in the core, each of the neutron-absorbing control rods comprising sliding elements moving relative to each other between an extended position separated along the axis in a first direction over a first length and a compacted position overlapping over a second length less than the first length and less than 51% of the core height. A control rod mechanism communicates with the control rods to move them for insertion and withdrawal into and out of the core.

It is thus a feature of at least one embodiment of the invention to significantly reduce silo costs through the use of telescoping control rods,

The first length of the extended control rods may be at least 80% of the core height.

It is thus a feature of at least one embodiment of the invention to provide a meaningful reduction in silo height without adversely affecting the function of the control rods to control the nuclear reaction.

The control rods may include at least three mutually sliding elements.

It is thus a feature of at least one embodiment of the invention to provide multipart control rods that can approach optimal silo height reduction.

The sliding elements may include at least two concentric cylindrical tubes surrounding a central rod, and the cross-sectional area of an outer-most concentric cylindrical tube maybe greater than a cross-section of the central rod.

It is thus a feature of at least one embodiment of the invention to mitigate the spatial inefficiency associated with inner elements of concentric telescoping control rods by a nonuniform distribution of control rod area among the sliding elements.

The control rod mechanism may be contained fully within the pressure vessel.

It is thus a feature of at least one embodiment of the invention to substantially reduce the problems of penetrations through the pressurized vessel.

The control rod may be fit within a 150 mm diameter cylinder.

It is thus a feature of at least one embodiment of the invention to provide a control rod that can be used in established HTR designs.

The sliding elements may provide inter-element gaps therebetween allowing angulation between sliding elements out of an alignment with each other within a plane of the axis by at least two degrees.

It is thus a feature of at least one embodiment of the invention to prevent cogging or jamming of the control rod components within the bore.

At least one sliding element may provide a horizontally extending flange interfering with the core structure to limit insertion of the at least one sliding element into the core.

It is thus a feature of at least one embodiment of the invention to provide a control rod design that can be released under the force of gravity with reduced risk of falling into the core and collapsing.

The sliding elements may provide catch surfaces interfering to limit the separation of the sliding elements along the axis beyond the first length by inter-engaging of the catch surfaces.

It is thus a feature of at least one embodiment of the invention to prevent inadvertent self-disassembly of the core components beyond the first length.

The sliding elements may provide catch surfaces preventing the sliding elements from separating along the axis in an extended position in the second direction beyond a lowest end of a key element attached to the control rod mechanism.

It is thus a feature of at least one embodiment of the invention to allow a single sliding element to be attached to the control rod assembly to define the length of the control rod.

In one embodiment, the sliding elements provide petals extending away from the axis along lines of radius wherein a line of radius for each different sliding element is angularly displaced from the others about the axis so that the sliding elements may interfit in the compacted position.

It is thus a feature of at least one embodiment of the invention to provide a telescoping control rod with substantially uniform spatial efficiency along its length when extended.

In one embodiment, the sliding elements may provide petals extending away from the axis along lines of radius wherein a line of radius for each different sliding element is angularly displaced from the others about the axis so that the sliding elements may interfit in the compacted position.

It is thus a feature of at least one embodiment of the invention to provide a compact control rod having equal cross-sectional area elements.

In one embodiment, the sliding elements may provide a set of adjacent elements whose respective cross-sectional centers of mass are displaced from each other along a plane perpendicular to their axes of motion.

It is thus a feature of at least one embodiment of the invention to provide a collapsible control rod where the sliding elements can be, for example, plates, oriented in a uniformly optimal direction (e.g., normal to the principal direction of neutron current).

These particular objects and advantages may apply to only some embodiments falling within the claims and thus do not define the scope of the invention.

### BRIEF DESCRIPTION OF THE DRAWINGS

FIG. 1 is a perspective, phantom, breakaway view of an example high temperature nuclear reactor having a reactor core held within a pressure vessel held within a silo also holding a control rod assembly, the reactor core being comprised of graphite blocks having fuel bores holding fuel and a control rod bore holding a control rod shown in successive inserts;

FIG. 2 is a cross sectional fragmentary view taken along line 2-2 of a simplified (three-part) telescoping control rod in a fully retracted position according to the present invention;

FIG. 3 is a figure similar to that of FIG. 2 showing the control rod in a fully extended position;

FIG. 4 is an elevational fragmentary view of a first embodiment of the pressure vessel within the silo showing a reduction in silo height reducing excavation and construction cost;

FIG. 5 is a figure similar to that of FIG. 4 showing an increased height pressure vessel incorporating the control rod actuation mechanism within the pressure vessel to minimize weakening penetrations of the pressure vessel;

FIG. 6 is a simplified cross-sectional view of a multipart core having five cores showing a boosting of cross-sectional area of the center-most elements to offset decreases in spatial efficiency;

FIG. 7 is an alternative control rod embodiment using wedge-shaped sectors having substantially more equal spatial efficiency and worth;

FIG. 8 is an exploded perspective view of the sectors of the core of FIG. 7 separated for clarity;

FIG. 9 is a plot of reduction in silo height as a function of telescoping element numbers showing a reduction of approximately 80% of the core height with five telescoping elements;

FIG. 10 a perspective, fragmentary view of an alternative control rod embodiment using a set of adjacent plates; and

FIG. 11 is a figure similar to that of FIG. 2 showing the interconnection of the plates to promote an orderly telescoping of the sections.

### DETAILED DESCRIPTION OF THE PREFERRED EMBODIMENT

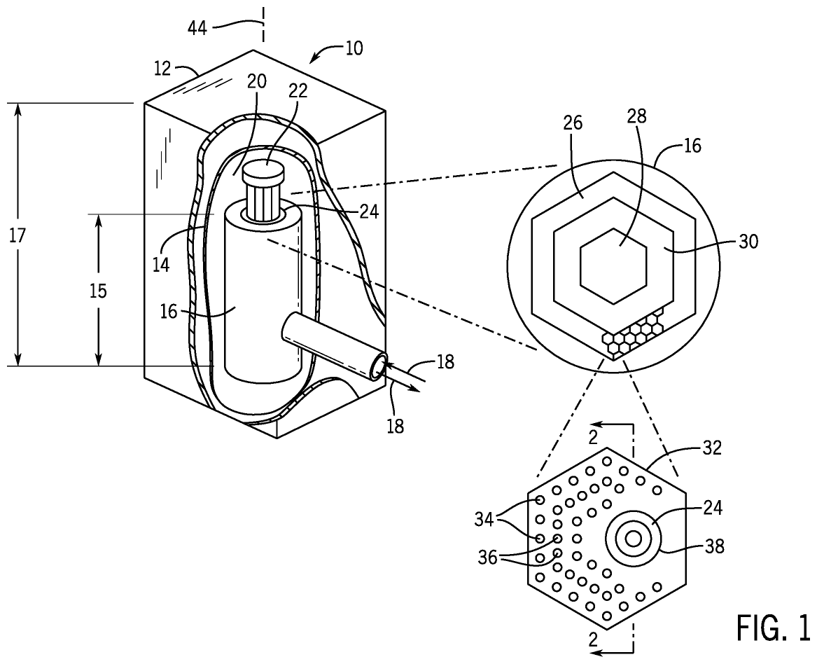

Referring now to FIG. 1, a simplified high-temperature nuclear reactor 10 provides for a containment silo 12 holding a pressure vessel 14 having a core 16 heated by a nuclear reaction. In a typical HTR reactor, the core may have a height 15 from 4 to 8 meters tall and the silo may have a height from 12 to 40 meters tall.

The pressure vessel 14 surrounds the core to allow circulation of a heat exchanging gas 18 such as helium to carry heat to a separate energy producing element (not shown), for example, providing for the extraction of energy using a thermodynamic cycle. In one example, the pressure vessel 14 may operate at 60-70 bar, receiving helium at 325 degrees Celsius and heating it to about 750 degrees Celsius with a core pressure drop of 2-3 bar.

A space 21 above the core 16 outside of the pressure vessel 14 but within the silo 12 may hold a control rod drive mechanism 22 positioned above a set of control rods 24 within a headspace 20 above the core 16 and within the pressure vessel which may be raised or lowered into the core 16 to control the rate of reaction. The control rod drive mechanism 22, for example, may provide for electric motors moving cables or racks attached to the individual or adjacent groups of control rods 24. Often the attachment is by means of an electromagnet to allow the control rods 24 to drop rapidly into the core 16 under the force of gravity in the event of emergency. When fully extended within the operating course 16, the control rods 24 may experience a temperature gradient of about 40 degrees centigrade per meter.

The core 16 may include an outer reflector shell 26 and, in some configurations, a coaxial inner reflector shell 28, for example, of graphite, the outer reflector shell 26 and coaxial inner reflector shell 28 together flanking a reactor annulus 30. In this capacity, the outer reflector shell 26 and inner reflector shell 28 serve to reflect neutrons from the reactor annulus 30 back into the reactor annulus 30.

The reactor annulus 30 may be comprised of a set of hexagonal graphite blocks 32 providing multiple vertically extending fuel bores 34 and interspersed vertically extending gas bores 36. The fuel bores 34 and gas bores 36 are in thermal communication so that the heat of nuclear reaction from fuel in the fuel bores 34 can pass to the gas in the gas bores 36 circulated as discussed above. Each graphite block 32 (and the outer reflector shell 26) may have one or more vertically extending control rod bores 38 (for example, 130 mm in diameter) receiving a control rod 24, the latter operating to moderate the nuclear reaction by being inserted into the control rod bore 38 by different amounts to absorb neutrons. Additional bores (not labeled) may provide for the receipt of boron-containing balls that may be poured into these bores as a failsafe measure if the control rods 24 fail to insert.

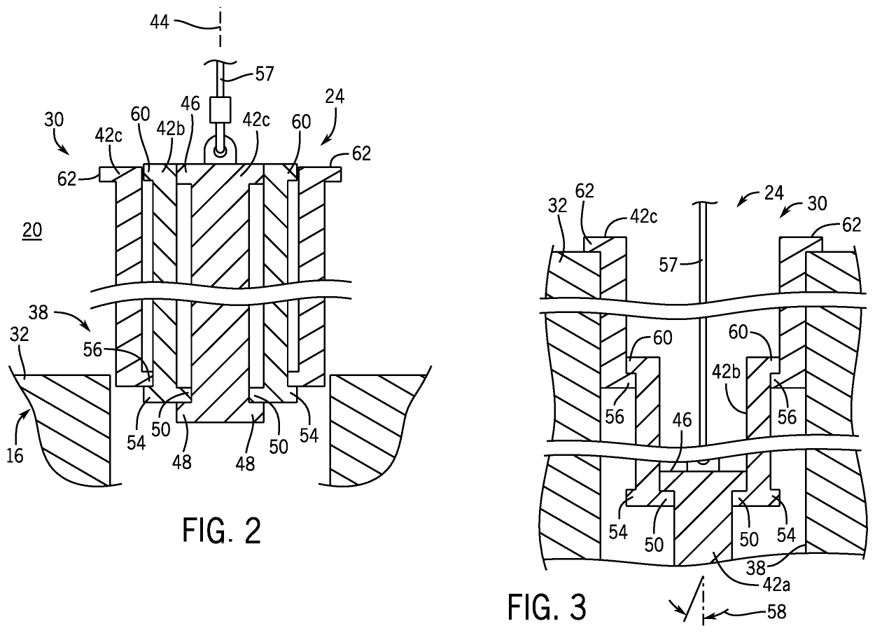

Referring now to FIG. 2, a simplified control rod 24 in a fully retracted position outside of the core 16 and control rod bores 38 may provide a central cylindrical rod element 42a (solid or tubular) slightly fitting within one or more coaxial tubular elements 42b-42c which are also arranged to slide with respect to the others along an insertion axis 44. Each of the coaxial elements 42 is designed to absorb neutrons and for this purpose may be a boron carbide in a graphite matrix. Each of the elements 42 may be further clad internally and externally, for example, with a nickel-based alloy (austenitic nickel-chromium high temperature super alloy available under the trade name Inconel) recognized for use in high temperature reactors (e.g., alloy 800H or alloy 617). The clearance between the elements 42 is such as to allow a tipping of the elements 42 with respect to each other along the axis 44 (angulation within a plane including the axis 44) to eliminate binding within the bore 38.

The reactor annulus 30 may alternatively be comprised of spherical graphite-coated pebbles, many of which contain fuel, with gas passing between the pebbles. In this configuration, all control rods and boron-containing balls are inserted through holes in the reflector as in the configuration described above.

In one embodiment, the elements 42 may be fabricated using powder-sintered boron graphite which is then diamond machined. In one embodiment, the cladding materials on either side of a sliding interface may be different, for example, using exposed boron carbide on one surface and an Inconel cladding on the other surface both to polish and to reduce surface friction. In this latter example, the Inconel cladding (or similar material) would be on the outer surface of each element 42 to avoid tensile stress in the boron carbide caused by dissimilar coefficients of thermal expansion.

The central cylindrical rod element 42a may have an upper outwardly extending radial flange 46 and lower outwardly extending radial flange 48.

The lower flange 48 underlies and engages with a corresponding inwardly extending lower radial flange 50 of the succeeding coaxial tubular element 42b serving to retain that tubular element 42b against descending past the rod element 42a by sliding under the force of gravity.

Similarly, the succeeding coaxial tubular element 42b has a lowermost outwardly extending radial flange 54 which underlies and engages a corresponding inwardly extending lower radial flange 56 of the tubular element 42c serving to retain a tubular element 42c against descending past the tubular element 42b by sliding under the force of gravity.

In this way, the rod element 42a alone may be suspended by a cable 57 communicating with the control rod drive mechanism 22 to control the descent of tubular elements 42b and 42c and to retract all of the elements 42 to the fully retracted position as shown. Friction between the elements is limited to ensure that the extended rod is always at the lowest potential state for a given control rod input, i.e., the rods extended in predictable and predetermined sequence. This may be achieved by geometry designed to limit the contact area between elements, low friction coatings, increased radial clearance between elements, or equivalent.

Referring now to FIG. 3, the outwardly radially extending flange 46 of the central rod element 42a is limited in its descent with respect to the tubular element 42b by the upper surface of the radially inward flange 50 of the tubular element 42b which prevents the upper end of the rod element 42a from moving past the lower end of the tubular element 42b.

Similarly, the upper end of the tubular element 42b cannot move below the lower end of the tubular element 42c because of interference between a radially outwardly extending flange 60 at the upper edge of the cylindrical tubular element 42b which strikes an upper surface of the inwardly extending flange 56 on tubular element 42c.

Finally, the tubular element 42c has at its upper edge an outwardly extending radial flange 62 which prevents the upper edge of the tubular element 42c from descending below an upper lip of the bore 38. In this way, even with loss of the control cable 57, the elements will not disassemble but stay retained in a fully extended state.

The interface between elements 42 may further include damping elements to help resist oscillation with pneumatic flow of the gas past these elements 42 and/or interlocks or spring detents to prevent collapse of the telescoping arrangement under the flow of gas. Generally, the clearance between the elements 42 will be such as to allow an angulation 58 between the axes of the elements 42 of at least 2 degrees to resist binding within the bore 38.

It should be noted that each of the elements 42 taken alone and in extended form has not only a lower spatial efficiency but also a lower amount of control material mass compared to a comparable segment of a single piece of cylindrical control rod. Nevertheless, the present inventors have recognized that the dominant effect in control rod worth is spatial efficiency rather than total cross-sectional area or mass allowing multipart control rods (with multiple concentric elements 42) to be practical even though the total cross-sectional area per unit length of the extended control rod 24 is substantially reduced (by as much as five times for a five-part telescoping design). The present invention further contemplates that this reduced cross-sectional area can be offset in part by using a higher percentage of boron in the boron graphite composite of the control rods 24.

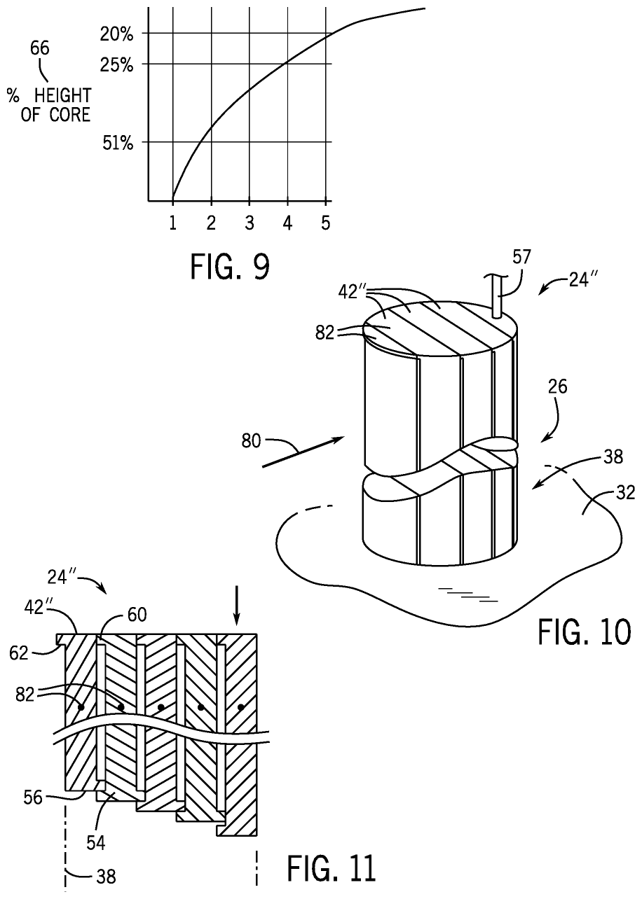

Referring now to FIG. 4, the headspace 20 above the reactor core 16 may be substantially reduced by the control rods 24 as described which, when fully retracted as shown in FIG. 2, require very little length along the retraction axis 44. Referring momentarily to FIG. 9, control rods having at least two different elements 42 can reduce the retracted height 66 of the control rods to less than 51% of the height of the core 15 and five different elements 42 (extending the principles described in FIG. 2 to include additional coaxial elements 42) are practical and can reduce the retracted height 66 of the control rods 24 to less than 30% of the height 15 of the core, with reductions in height 15 of less than 55%, 53%, 50% or 40% readily obtainable with commercially practical designs. These reductions in height are possible with control rods 24 that when fully extended extend to at least 80% of the core height 15. These height reductions permit a corresponding reduction in height in the silo 12 and thus a substantial cost savings in the construction of the silo 12. These latter costs rise super linearly and also affect secondary costs such as costs of heat loss, circulating gaseous material, and the like.

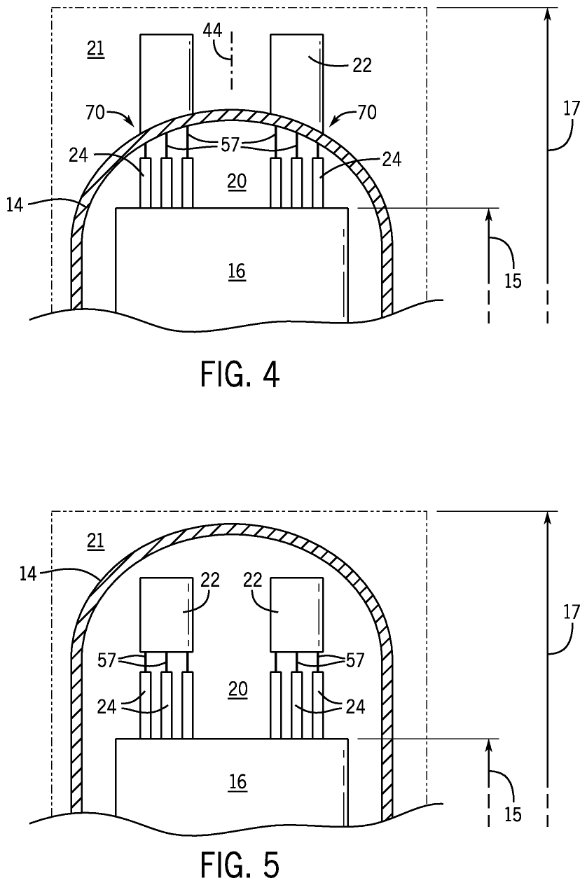

The control rod drive mechanism 22 is usually positioned outside of the pressure vessel 14 through penetrations 70 which increases the complexity of designing the pressure vessel 14. Accordingly, and referring to FIG. 5, with the reduced retracted height of the control rods 24, the control rod drive mechanism 22 may be alternatively completely incorporated into the pressure vessel 14 with an increase in the height of the pressure vessel representing a compromise between the cost of additional pressure vessel size and pressure vessel complexity eliminated by eliminating the penetrations.

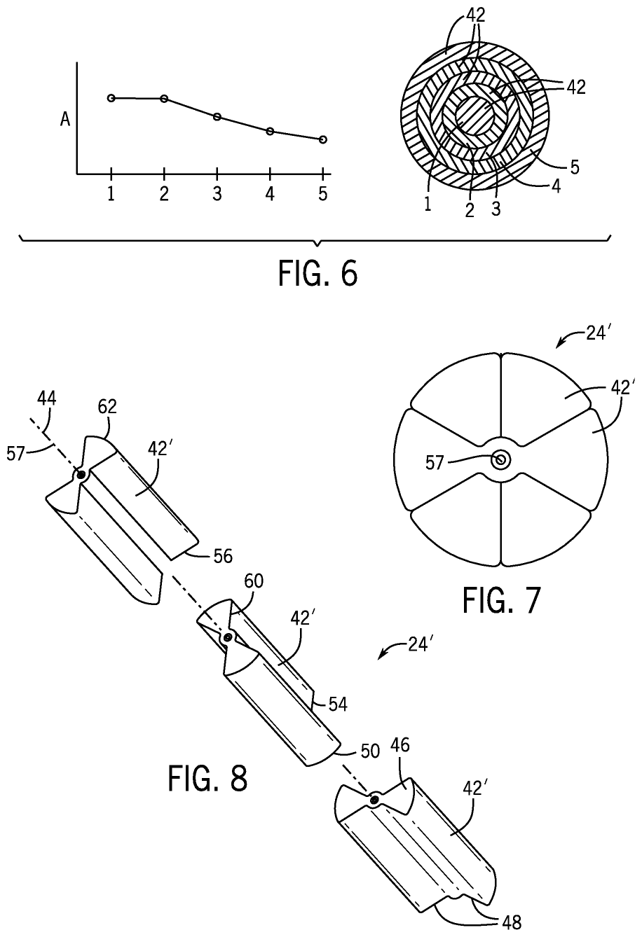

Referring now to FIG. 6, when a control rod 24 is produced having multiple coaxial elements, the worth of each element is not identical being a function of the absorptive qualities of the material of the element 42 and its spatial efficiency, a parameter related to the projected area of the element 42 along the path of neutrons which decreases with decreasing radius of the element 42. Accordingly, the present invention contemplates adjusting the cross-sectional area of the elements 42 of the control rod 24 so they are not equal but rather so that the cross-sectional area for the innermost elements are larger than the cross-sectional area of the outermost elements. In this way the linearity of neutron moderation with control rod extension is improved. Calculations indicate that the control rod of this design having five elements may reduce the worth of the control rod by less than 10% and cause an increased control rod depletion of less than three times as fast, results consistent with cost savings from reduction in pressure vessel size. The present inventors have also recognized that the increased control rod depletion may in part be accommodated by the fact that the control rods 24 are mostly withdrawn at power,

Referring now to FIGS. 7 and 8, the problem of variations in the worth of the different constituent control rod elements 42′ may be addressed by a control rod 24′ where each element 42′ has a cross-section that is a sector of a circle and thus may be of substantially spatial efficiency and equal worth with the other elements 42′. Alternatively, the worth as a function of depth can be tailored if this is deemed to be beneficial. The different sectors may be arranged around the common axis 44 and separately slidable with respect to each other and may include a flanging relationship as discussed above with respect to FIGS. 2 and 3 except the flanging is extending circumferentially to provide similar operation.

Referring now to FIGS. 10 and the 11, the problem of variations in the worth of the different constituent control rod elements may alternatively be addressed by a control rod 24″ where each element 42″ has a cross-section that is a thin plate, for example, with a rectangular or trapezium cross-section, with long axis normal to the primary direction of neutron current 80 and thus all elements may be of substantial spatial efficiency with the other elements 42″. The different plates may be arranged in parallel and separately slidable along different parallel axes with respect to each other and may include a flanging relationship as discussed above with respect to FIGS. 2 and 3 except the flanging is extending normal to the long axis of the plate. Generally, each plate will have a center of mass 82 separated along the axis 80 thus being differentiated from the concentric tubular elements described above. It will be appreciated that when the control rod bore 38 is rectangular or square in cross section, each of the elements 42″ may be identical in shape and cross-sectional area.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A nuclear reactor comprising:
a core of nuclear fuel having a height;
a pressure vessel surrounding the core of nuclear fuel to allow circulation of gas there through;
a set of neutron-absorbing control rods movable for insertion and withdrawal into and out of the core along a respective axis for control of a nuclear reaction in the core, each of the neutron-absorbing control rods comprising mutually sliding elements moving relative to each other between an extended position separated along the axis in a first direction over a first length and a compacted position overlapping over a second length less than the first length and less than 51% of the core height; and
a control rod mechanism communicating with the control rods to move them for insertion and withdraw into and out of the core.

2. The nuclear reactor of claim 1 wherein the first length is at least 80% of the core height

3. A nuclear reactor of claim 1 wherein the control rods comprise at least three mutually sliding elements moving relative to each other.

4. The nuclear reactor of claim 1 further comprising at least four mutually sliding elements and wherein the second length is less than 30% of the first length.

5. The nuclear reactor of claim 1 wherein the sliding elements include at least two concentric cylindrical tubes surrounding a central rod and wherein a cross-sectional area of an outer most concentric cylindrical tube is less than a cross-section of the central rod.

6. The nuclear reactor of claim 1 wherein the control rod mechanism is contained fully within the pressure vessel.

7. The nuclear reactor of claim 1 wherein the control rod is fit within a 150 mm diameter cylinder.

8. The nuclear reactor of claim 1 wherein the sliding elements provide inter-element gaps therebetween allowing angulation of the sliding elements out of an alignment with each other within a plane of the axis by at least two degrees.

9. The nuclear reactor of claim 1 wherein at least one sliding element provides a horizontally extending protrusion interfering with the core structure to limit insertion of the at least one sliding element into the core.

10. The nuclear reactor of claim 1 wherein the sliding elements provide catch surfaces interfering to limit a separation of the sliding elements along the respective axis beyond the first length by inter-engaging of the catch surfaces.

11. The nuclear reactor of claim 1 wherein the sliding elements provide catch surfaces preventing the sliding elements from separating along the axis in an extended position in the second direction beyond a lowest end of a key element attached to the control rod mechanism.

12. The nuclear reactor of claim 1 wherein the sliding elements provide petals extending away from the axis along lines of radius wherein a line of radius for each different sliding element is angularly displaced from the others about the axis so that the sliding elements may interfit in the compacted position.

13. The nuclear reactor of claim 12 wherein the petals are substantially identical in cross-sectional shape.

14. The nuclear reactor of claim 12 wherein the petals are substantially sectors of a circle in cross-sectional shape.

15. The nuclear reactor of claim 1 wherein the sliding elements provide a set of adjacent plates whose respective cross-sectional centers of mass are displaced from each other along a direction perpendicular to their axes of motion.

16. The nuclear reactor of claim 15 wherein the control rods are located in the reflector and the plates so that their broadest cross-sectional dimension is perpendicular to a direction facing the core.

17. A nuclear reactor comprising:
a core of nuclear fuel;
a pressure vessel surrounding the core of nuclear fuel to allow circulation of gas there through;
a set of neutron-absorbing control rods movable for insertion and withdrawal into and out of the core along a respective axis for control of a nuclear reaction in the core, each of the neutron-absorbing control rods comprising mutually sliding elements moving relative to each other between an extended position separated along the axis in a first direction over a first length and a compacted position overlapping over a second length less than the first length; and
a control rod mechanism communicating with the control rods to move them for insertion and withdraw into and out of the core; and
wherein the sliding elements provide petals extending away from the axis along lines of radius wherein a line of radius for each different sliding element is angularly displaced from the others about the axis so that the sliding elements may interfit in the compacted position.

18. A nuclear reactor comprising:
a core of nuclear fuel;
a pressure vessel surrounding the core of nuclear fuel to allow circulation of gas there through;
a set of neutron-absorbing control rods movable for insertion and withdrawal into and out of the core along different axes for control of a nuclear reaction in the core, each of the neutron-absorbing control rods comprising mutually sliding elements moving relative to each other between an extended position separated along the axis in a first direction over a first length and a compacted position overlapping over a second length less than the first length; and
a control rod mechanism communicating with the control rods to move them for insertion and withdraw into and out of the core; and
wherein the sliding elements provide a set of adjacent elements whose respective cross-sectional centers of mass are displaced from each other along a plane perpendicular to their axes of motion.
